(19) United States
(12) Patent Application Publication
(10) Pub. No.: US 2021/0192457 A1
(43) Pub. Date: Jun. 24, 2021

(54) SYSTEM USING END-USER MICRO-JOURNALING FOR MONITORING ORGANIZATIONAL HEALTH AND FOR IMPROVING END-USER OUTCOMES

(71) Applicant: FUJI XEROX CO., LTD., Tokyo (JP)

(72) Inventors: Daniel AVRAHAMI, Mountain View, CA (US); Matthew Len LEE, Mountain View, CA (US); Kristin WILLIAMS, Pittsburgh, PA (US); Yulius TJAHJADI, Palo Alto, CA (US); Nami TOKUNAGA, Yokohama (JP)

(21) Appl. No.: 16/725,909

(22) Filed: Dec. 23, 2019

(51) Int. Cl. G06Q 10/10; G06Q 10/06

(52) U.S. Cl. CPC G06Q 10/105; G06Q 10/0639; G06Q 10/063114

(57) ABSTRACT

Example implementations described herein are directed to a dual interface system configured to facilitate and analyze micro-journal entries. Example implementations can involve providing a first interface directed at a plurality of organizations, the first interface configured to receive micro-journal entries; aggregating the micro-journal entries across the plurality of organizations; providing analytics results of the micro-journal entries across the plurality of organizations to a second interface; receiving, through the second interface, a selection of an organization from the plurality of organizations for pushing a prompt based on the analytics results; and configuring the first interface of the selected organization from the plurality of organizations to provide the prompt, the prompt configured to receive additional micro-journal entries.

### BACKGROUND

### Field

The present disclosure is generally related to enterprise platforms, and more specifically, to platforms configured to facilitate end-user micro-journaling to monitor organizational health.

### Related Art

Related art implementations involve lengthy surveys to assess the multiple dimensions of organizational health and the negative and protective factors that contribute to organizational health. For example, polling organizations utilize a series of surveys to measure job satisfaction and engagement. In related art implementations, employee survey responses are automatically collated in a dashboard for managers. Even though survey results can be valuable for managers, employees may gain little direct value from the results and may be annoyed when spending the time and effort to complete these questions.

In another related art implementation, a conversational system prompts users with various questions for reflection. Such related art implementations focused on the intersection of reflective prompt and modality in which that prompt was delivered (voice vs. chat).

### SUMMARY

Example implementations described herein are directed to a platform facilitating a micro-journaling solution which is directed to balancing benefits for the workers (e.g., helping increase measures of motivation, engagement, etc. and helping them compose progress reports) and benefits for the organization. Example implementations facilitate a lightweight interaction (e.g., taking less than 1-minute over repeated periods) and can help workers reflect on positive aspects of their work, which leads to the worker experiencing more positive emotions and an immediate reward for such short interactions.

The example implementations involve a platform that facilitates aggregated analytics and actions at the organization level, as well as a tie to outcome measures.

Example implementations can involve an enterprise platform that assists users (e.g. employees of an organization) improve motivation and reduce negative affect through positive micro-journaling. The example implementations take advantage of these user-composed records to provide an estimate of organizational health. Specifically, the presence of micro-journal records along with aggregated analysis of record content allows for the estimation of overall stress level, affect, burnout, and so on, while further assisting users to compose reports. Example implementations facilitate the ability to target areas that require further analysis or improvement by the organization, or that was identified as a risk area by delivering organizationally-relevant journaling prompts.

Aspects of the present disclosure involve a method, which can involve providing a first interface directed at a plurality of organizations, the first interface configured to receive micro journal entries; aggregating the micro-journal entries across the plurality of organizations; providing analytics results of the micro-journal entries across the plurality of organizations to a second interface; receiving, through the second interface, a selection of an organization from the plurality of organizations for pushing a prompt based on the analytics results; and configuring the first interface of the selected organization from the plurality of organizations to provide the prompt, the prompt configured to receive additional micro-journal entries.

Aspects of the present disclosure involve a computer program, storing instructions which can involve providing a first interface directed at a plurality of organizations, the first interface configured to receive micro-journal entries; aggregating the micro-journal entries across the plurality of organizations; providing analytics results of the micro-journal entries across the plurality of organizations to a second interface; receiving, through the second interface, a selection of an organization from the plurality of organizations for pushing a prompt based on the analytics results; and configuring the first interface of the selected organization from the plurality of organizations to provide the prompt, the prompt configured to receive additional micro-journal entries. The instructions can be stored on a non-transitory computer readable medium and configured to be executed by one or more processors.

Aspects of the present disclosure involve a system, which can involve means for providing a first interface directed at a plurality of organizations, the first interface configured to receive micro-journal entries; means for aggregating the micro-journal entries across the plurality of organizations; means for providing analytics results of the micro-journal entries across the plurality of organizations to a second interface; means for receiving, through the second interface, a selection of an organization from the plurality of organizations for pushing a prompt based on the analytics results; and means for configuring the first interface of the selected organization from the plurality of organizations to provide the prompt, the prompt configured to receive additional micro-journal entries.

Aspects of the present disclosure can involve an apparatus, involving a processor, configured to provide a first interface directed at a plurality of organizations, the first interface configured to receive micro-journal entries; aggregate the micro-journal entries across the plurality of organizations; provide analytics results of the micro-journal entries across the plurality of organizations to a second interface; receive, through the second interface, a selection of an organization from the plurality of organizations for pushing a prompt based on the analytics results; and configure the first interface of the selected organization from the plurality of organizations to provide the prompt, the prompt configured to receive additional micro-journal entries.

### BRIEF DESCRIPTION OF DRAWINGS

FIG. 1 illustrates an example system diagram, in accordance with an example implementation.

FIG. 2 illustrates an example of the end-user micro-journaling application, in accordance with an example implementation.

FIG. 3 illustrates an organizational-health dashboard, in accordance with an example implementation.

FIGS. 4(a) and 4(b) illustrate examples of prompts, in accordance with an example implementation.

FIG. 5 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations involve an enterprise platform that facilitates Improving motivation and engagement, and reducing negative affect are key goals (and challenges) for behavior-change solutions. At an organizational level, sensing organizational health is important in order to improve the well-being of members of the organization (e.g., employees) and identify problems early. Otherwise, an organization may discover too late a problem (e.g., high burnout and low satisfaction within parts of the organization).

Moreover, studies have shown that certain behaviors are beneficial for workers in an organization to feel engaged, motivated, and equipped to meet the demands of their job. These helpful behaviors include making decisions that matter to them, planning for the future, developing skills to help them do their job better, having adequate resources, and giving/receiving social support. Such behaviors can be difficult for organizations, and even workers, to track and measure. Thus, not only do organizations need better ways of tracking engagement, but they also need better ways of tracking the behaviors that lead to greater engagement.

One data source that can provide a regular indicator of these metrics can include worker-authored highlights of their work day.

Example implementations described herein involve the following aspects. In a first aspect, the platform proposed herein facilitates an end-user behavior-change application for recording micro-journal entries and providing visual and textual summaries. Micro-journaling is the activity of composing short journal entries (e.g. daily).

An organizational-level journal-entry aggregator and content analyzer (an Organization can be a group/team, company, etc.).

A dashboard for displaying analysis results as they pertain to organizational health (e.g., over time) and alerting to potential issues. This is used by a representative of the organization (e.g., manager, counselor, HR, etc.)

A mechanism for the organization's representative to target prompts to attempt to address issues uncovered in the dashboard.

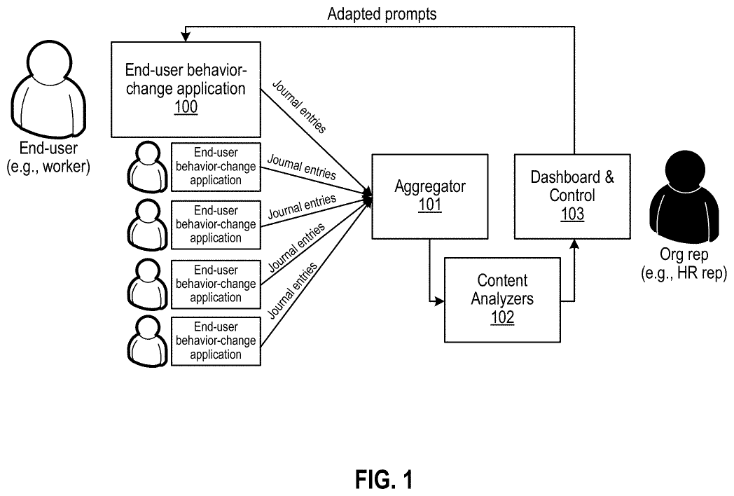

FIG. 1 illustrates an example system diagram, in accordance with an example implementation. In the system as illustrated in FIG. 1, there is an end-user application 100 that is deployed to be accessible by multiple users in the system (e.g., locally on a local device, through an intranet, or through a website). The end-user application is directed to facilitate positive micro-journaling functions to affect behavior change. In an example function, an interface is provided in which users record a single daily work highlight. Through using such an interface with a focus on positive progress at the work environment, there can be a significant effect on employee engagement and on positive affect (emotion) at work. The entries in this application also help users generate reports about their progress. The journal entries generated through the end-user behavior change application 100 are then provided to an aggregator 101 that aggregates the journal entries to provide to a content analyzer 102. The content analyzer 102 can then conduct analytics on the aggregated journal entry for displaying analytics on a dashboard 103. The dashboard interface 103 is managed by a representative of the company (e.g., a human resources manager, etc.) and also allows the user of the dashboard 103 to control prompts and other functionality on the end-user behavior change application 100. For example, a change in prompts can be implemented, or specific prompts can be provided to particular end-users.

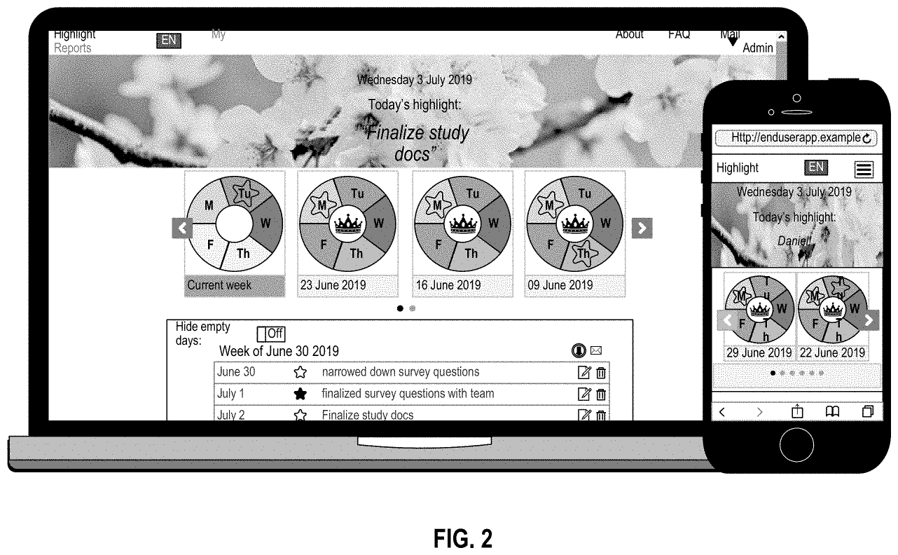

FIG. 2 illustrates an example of the end-user micro-journaling application, in accordance with an example implementation. In an example implementation, micro-journal entries can follow a general prompt (e.g., “Please list a top highlight for today”) or the system can dispatch other prompts based on organizational needs or identified (e.g., impending) issues. For example, prompts for micro-journaling highlights can target specific aspects of a user day or behavior (e.g., “Please list a top highlight involving an interaction with a co-worker”).

Further, the content of highlights recorded by workers can provide a potential window into both successes and challenges in the workplace. These challenges can impact organizational health and its ability to function, grow, and adapt well. For example, the sentiment of highlights may not always be positive (e.g., and may be useful for predicting worker stress). Similarly, some highlights describe social interactions, or overcoming hurdles. Thus, micro-journal entries can capture both negative factors (such as stress, overwork, conflict) but also positive, protective factors (such as social support, accomplishments, and skill development). Such micro journal entries, in aggregate over time and across multiple employees, can be used to better understand the organization, its state and health. For example, sentiment analysis on journal entries can provide an understanding of stress level within the organization. Sentiment analysis of entries with references to team members, meetings, supervisors, or other people can reveal whether that relationship is consistently supportive or can be improved. The presence or absence of highlights can also potentially indicate issues (e.g., that members do not feel they have accomplished anything valuable). The lack of highlights of a certain character (e.g., describing social interaction) may be a problem, and the organization may want to investigate further (by dispatching relevant prompts).

In the example implementation as illustrated in FIG. 2, the interface shows a request for a micro-journal entry for each day of the week. A star that highlights a day indicates the top highlight of the week as determined by the end user application 100. Each day may be shaded or colored with a darker color to indicate that a micro-journal entry was provided for that day, wherein lighter shaded days or colors can indicate that there was no micro-journal entry entered for that day. A crown indicates to the user that micro-journal entries were entered for each day of that week. As illustrated in FIG. 2, the end user application 100 can be in the form of a web-based application facilitated by a webserver and accessible by a user device via the internet or intranet.

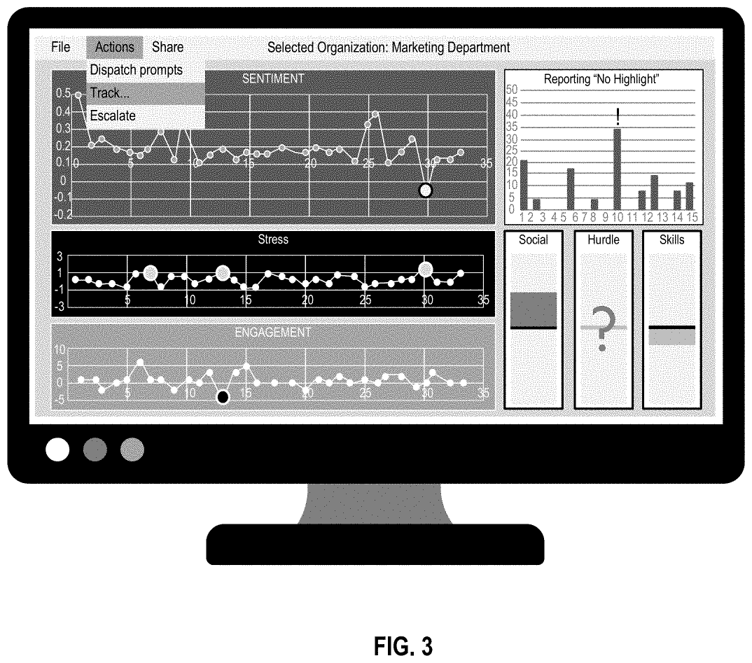

FIG. 3 illustrates an organizational-health dashboard, in accordance with an example implementation. In the example of FIG. 3, the organization selected is the marketing department within a company. When a particular organization from the plurality of organizations within the company is selected, dashboard 103 can be configured to affect the end user application 100 only for the members of the selected organization. In this manner, targeted analytics can be conducted for a particular organization within the company instead of all of the organizations, whereupon the user of the dashboard 103 can push prompts specific to that organization. Further, targeting an organization within the company instead of an individual allows for the end users to feel more encouraged to provide the micro-journal entries as the prompts are not directed to an individual.

Similar to the end user application 100 of FIG. 2, the dashboard 103 can be in the form of a web-based application facilitated by a webserver and accessible by a user device via the internet or intranet, in accordance with the desired implementation.

In an example implementation of dashboard 103, there is an application with a dashboard operated by a representative of the organization, such as a manager, group counselor, human-resources representative, and so on. The dashboard 103 serves to visually and numerically represent the result of the analysis and reflect the organizational health along several dimensions, such as stress, engagement, sociability, morale, and performance (e.g., if a correlation is determined between features or journal entries and productivity). This representation can be, for example, be shown as change over time, and alert the operator to any significant changes. Such a dashboard 103 can be utilized weekly, monthly, or even at longer intervals (e.g. quarterly) depending on the desired implementation.

Further, should the organizational representative decide to either act on a detected problematic change in organizational health, or if they decide that they have insufficient information about a particular aspect of the organization's health (e.g., not enough information about worker stress level), the user of the dashboard will be able to select to investigate or address this aspect by having the system choose and dispatch different micro-journaling prompts in the end-user application.

In an example function of the dashboard 103, the hurdles interface (indicated by the question mark) is configured to push recommendations to the end user application 100 based on inputs from the manager of the dashboard 103 regarding manager specified hurdles. In such an example implementation, the analytics dashboard may indicate some analysis indicating difficulties being encountered by users of the end user application, but with insufficient information regarding the root cause analysis. When the hurdles function is used, the dashboard 103 can provide recommendations based on the analysis that can be pushed to the end user application 100, or the manager can specify a prompt to a particular organization or organizations as to whether end users are encountering some difficulties and if they are able to overcome them. In response to the specification, the dashboard 103 then configures the end user application 100 of the specified organization(s) to execute the recommendation or the manager specified prompt and thereby provide prompts regarding encountered difficulties (e.g. a prompt indicating “what is your daily highlight?” or “describe a difficult event that you overcame”.) Once such prompts are received, the end users of the end user application 100 receives input through the configured prompts which are processed in the content analyzers 102 to provide analysis on the feedback received.

In the example dashboard 103 of FIG. 3, sentiment, engagement, and stress are measured with metrics in accordance with the desired implementation. Suppose one of the metrics goes below a threshold for a particular organization. In such an example implementation, the dashboard can provide an analysis regarding the situation (e.g., stress is increased because members of the organization have become more busy) and a recommendation (e.g., schedule a luncheon or company event). The recommendation can be presented as a functional option through the dashboard 103 (e.g., an interface popup that schedules an organization lunch, etc.)

If the recommendation is selected, notifications or corresponding prompts are pushed onto the end user application 100 (e.g., a notification that a lunch has been scheduled for the organization at some date, meetings are canceled for a specific date, etc.).

Once such prompts are pushed onto the end user application 100, then the dashboard 103 can record when the prompts were pushed (e.g., via a notification indicating that a particular prompt was pushed on that day) then tracks what happens afterwards for display on the dashboard 103, such that the manager of the dashboard 103 can determine whether such recommendations or pushed prompts have influenced the data or analysis or not. The manager of the dashboard 103 therefore is provided with more concrete information regarding the effects of the actions.

In the example of FIG. 3, the dashboard 103 can be configured to initiate recording of aggregated results for the provided prompt and provide an indication regarding when the prompt was provided to the first interface of the selected organization based on the “Track” function as illustrated under the “Actions” tab. Once the “Track” function is selected, the user of the dashboard 103 can select which of the dispatched prompts are to be recorded, whereupon the dashboard 103 can provide the results of the prompt starting from the date of dispatch.

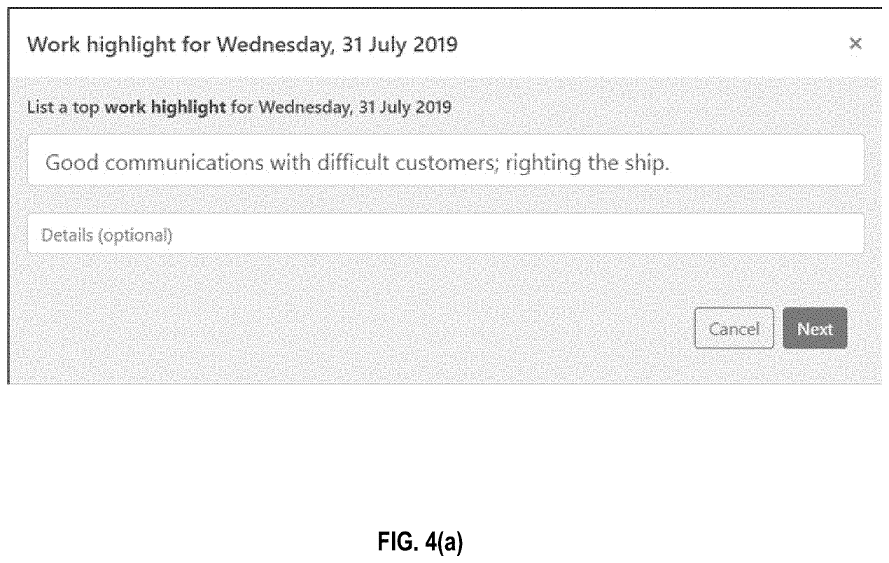

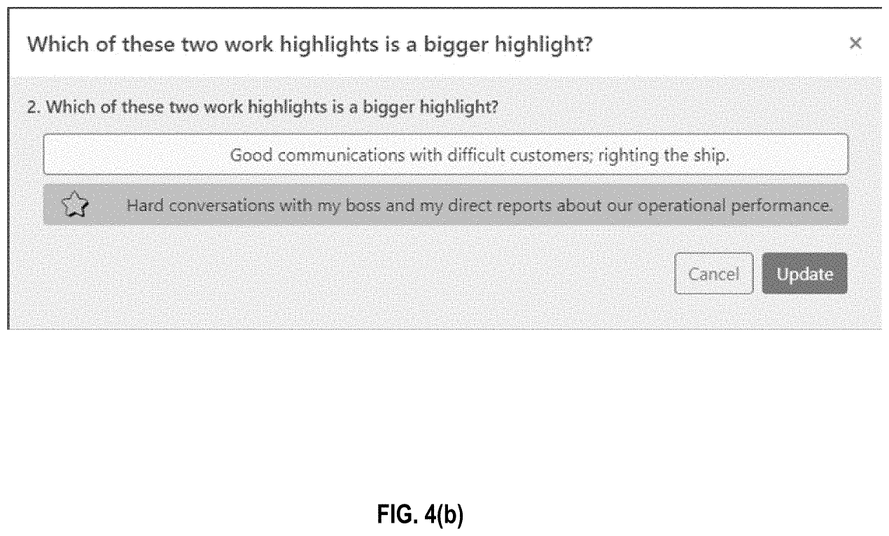

FIGS. 4(a) and 4(b) illustrate examples of prompts in accordance with an example implementation. Micro-journaling can not only be a way of monitoring organizational health but help improve worker engagement or motivation which leads to improving organizational health. The system can use prompts to direct the worker to reflect on specific behaviors or resources to help them cope with work stressors. For example, the system can present a prompt to help workers focus on knowledge/skill development by asking “What is one new knowledge highlight you learned today that can help you in your work?” Likewise, workers need to be equipped with the right resources to get their work done and reflecting on these can make workers feel more capable to do their job. The system can prompt, for example, “What your highlight tool or equipment that you were glad you had to help you do your work?”. The prompts can be free-text entry such as illustrated in FIG. 4(a), or can be multiple choice such as illustrated in FIG. 4(b).

In addition to manager-driven approach, the system can use semi-automated approach to customize prompts to help members of the organization focus on a breadth of positive behaviors that may help them meet the demands of more challenging aspects of their job. As the system collects highlights via general and more specific prompts, the system might detect, for example, that perceived social support is quite high but workers are getting frustrated due to a lack of opportunities to plan for the future (e.g., perhaps due to rapidly changing market demands). Instead of the repeatedly prompting members to reflect on planning opportunities, the system can prompt members to focus on the other supportive and adaptive behaviors that to greater motivation and engagement such as skill development, having decision latitude, and good social support to cope with the uncertainty associated with the lack of planning opportunities.

In example implementations, the prompts can also be replaced by email communications to request details or something more specific in case the prompt is insufficient. In an example, suppose the content analysis reveals that a particular organization does not provide any response to micro-journal entries on a specific day (e.g., Friday). In such an example, an e-mail may be dispatched to a selected organization reminding members of a particular organization or organizations to post micro-journal entries for a particular date. Such a dispatched e-mail can also be accompanied by a configuration of the end user application 100 highlighting a particular date for a micro-journal entry.

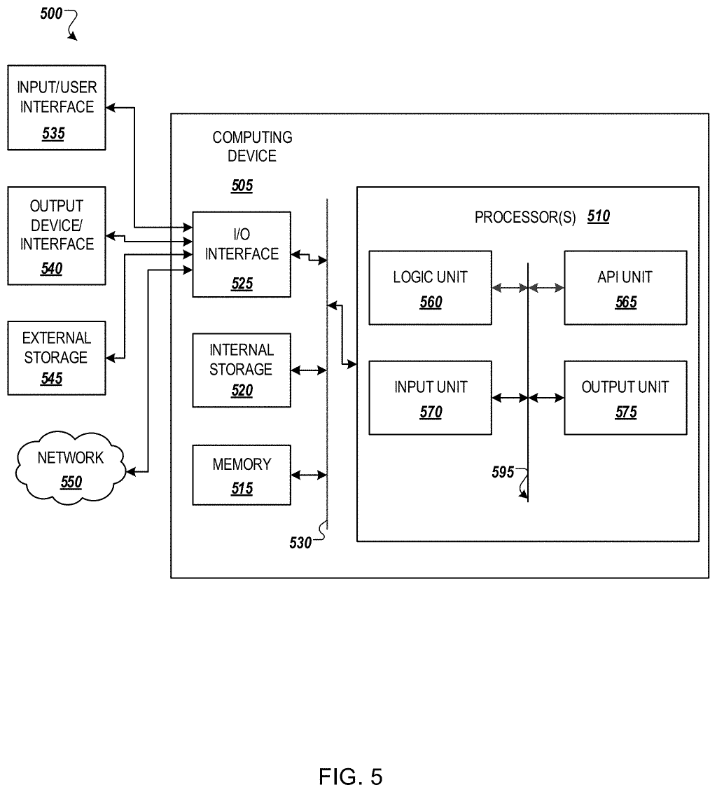

FIG. 5 illustrates an example computing environment with an example computer device suitable for use in some example implementations. In example implementations, the computing environment can be in the form of a webserver that facilitates the end user application 100 and the dashboard 103, or can be a server facilitating the applications over an intranet depending on the desired implementation. In such an example implementation, users can log into the webserver or intranet server and upon providing their credentials, be taken to their corresponding end user application 100 or dashboard 103 respectively. The computing environment can also facilitate the functionality of aggregator 101 and content analyzers 102 via processor(s) 510. Aggregator 101 and content analyzers 102 can be implemented through any method known in the art, and content analyzers 102 can implement any desired analytics algorithm in accordance with the desired implementation (e.g., algorithms measuring company metrics, any form of sentiment algorithm etc.).

Computer device 505 in computing environment 500 can include one or more processing units, cores, or processors 510, memory 515 (e.g., RAM, ROM, and/or the like), internal storage 520 (e.g., magnetic, optical, solid state storage, and/or organic), and/or I/O interface 525, any of which can be coupled on a communication mechanism or bus 530 for communicating information or embedded in the computer device 505. I/O interface 525 is also configured to receive images from cameras or provide images to projectors or displays, depending on the desired implementation.

Computer device 505 can be communicatively coupled to input/user interface 535 and output device/interface 540. Either one or both of input/user interface 535 and output device/interface 540 can be a wired or wireless interface and can be detachable. Input/user interface 535 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 540 may include a display, television, monitor, printer, speaker, braille, or the like. In some example implementations, input/user interface 535 and output device/interface 540 can be embedded with or physically coupled to the computer device 505. In other example implementations, other computer devices may function as or provide the functions of input/user interface 535 and output device/interface 540 for a computer device 505.

Examples of computer device 505 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 505 can be communicatively coupled (e.g., via I/O interface 525) to external storage 545 and network 550 for communicating with any number of networked components, devices, and systems, including one or more computer devices of the same or different configuration. Computer device 505 or any connected computer device can be functioning as, providing services of, or referred to as a server, client, thin server, general machine, special-purpose machine, or another label.

I/O interface 525 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 500. Network 550 can be any network or combination of networks (e.g., the Internet, local area network, wide area network, a telephonic network, a cellular network, satellite network, and the like).

Computer device 505 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 505 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 510 can execute under any operating system (OS) (not shown), in a native or virtual environment. One or more applications can be deployed that include logic unit 560, application programming interface (API) unit 565, input unit 570, output unit 575, and inter-unit communication mechanism 595 for the different units to communicate with each other, with the OS, and with other applications (not shown). The described units and elements can be varied in design, function, configuration, or implementation and are not limited to the descriptions provided. Processor(s) 510 can be in the form of hardware processors such as central processing units (CPUs) or in a combination of hardware and software processors.

In some example implementations, when information or an execution instruction is received by API unit 565, it may be communicated to one or more other units (e.g., logic unit 560, input unit 570, output unit 575). In some instances, logic unit 560 may be configured to control the information flow among the units and direct the services provided by API unit 565, input unit 570, output unit 575, in some example implementations described above. For example, the flow of one or more processes or implementations may be controlled by logic unit 560 alone or in conjunction with API unit 565. The input unit 570 may be configured to obtain input for the calculations described in the example implementations, and the output unit 575 may be configured to provide output based on the calculations described in example implementations.

Processor(s) 510 can be configured to provide a first interface directed at a plurality of organizations, the first interface configured to receive micro-journal entries as illustrated at FIGS. 2, 4(a) and 4(b); aggregate the micro-journal entries across the plurality of organizations as shown in FIG. 1; provide analytics results of the micro-journal entries across the plurality of organizations to a second interface as shown in FIG. 3; receive, through the second interface, a selection of an organization from the plurality of organizations for pushing a prompt based on the analytics results as shown in FIG. 3; and configure the first interface of the selected organization from the plurality of organizations to provide the prompt, the prompt configured to receive additional micro-journal entries as shown in FIGS. 4(a) and 4(b).

In an example implementation, the second interface as illustrated in FIG. 3 is configured to initiate recording of aggregated results for the provided prompt and provide an indication regarding when the prompt was provided to the first interface of the selected organization.

As illustrated in FIG. 4(b), the prompt can involve a comparison between a plurality of the micro-journal entries and is configured to receive an input regarding which of the plurality of the micro-journal entries is more important.

Depending on the desired implementation wherein the second interface is configured to provide a recommendation for the organization from the plurality of organizations based on the analytics results, wherein upon selection of pushing the recommendation to the organization, wherein the processor(s) 510 is configured to configure the first interface to provide one of a notification or a prompt according to the recommendation.

As illustrated in FIG. 3, the second interface is configured to display the analytics results for the selected organization. In the example of FIG. 3, the selected organization as indicated in the interface is the marketing department, however, the organizations can be categorized in accordance with the desired implementation according to the underlying company.

Depending on the desired implementation, the processor(s) 510 is configured to configure the first interface only for the selected organization from the plurality of organizations.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
providing a first interface directed at a plurality of organizations, the first interface configured to receive micro-journal entries;
aggregating the micro-journal entries across the plurality of organizations;
providing analytics results of the micro-journal entries across the plurality of organizations to a second interface;
receiving, through the second interface, a selection of an organization from the plurality of organizations for pushing a prompt based on the analytics results; and configuring the first interface of the selected organization from the plurality of organizations to provide the prompt, the prompt configured to receive additional micro-journal entries.

2. The method of claim 1, wherein the second interface is configured to initiate recording of aggregated results for the provided prompt and provide an indication regarding when the prompt was provided to the first interface of the selected organization.

3. The method of claim 1, wherein the prompt comprises a comparison between a plurality of the micro-journal entries and is configured to receive an input regarding which of the plurality of the micro-journal entries is more important.

4. The method of claim 1, wherein the second interface is configured to provide a recommendation for the organization from the plurality of organizations based on the analytics results, wherein upon selection of pushing the recommendation to the organization, configuring the first interface to provide one of a notification or a prompt according to the recommendation.

5. The method of claim 1, wherein the second interface is configured to display the analytics results for the selected organization.

6. The method of claim 1, wherein the configuring of the first interface is conducted only for the selected organization from the plurality of organizations.

7. A non-transitory computer readable medium, storing instructions for executing a process, the instructions, comprising:
providing a first interface directed at a plurality of organizations, the first interface configured to receive micro-journal entries;
aggregating the micro-journal entries across the plurality of organizations;
providing analytics results of the micro-journal entries across the plurality of organizations to a second interface;
receiving, through the second interface, a selection of an organization from the plurality of organizations for pushing a prompt based on the analytics results; and
configuring the first interface of the selected organization from the plurality of organizations to provide the prompt, the prompt configured to receive additional micro-journal entries.

8. The non-transitory computer readable medium of claim 7, wherein the second interface is configured to initiate recording of aggregated results for the provided prompt and provide an indication regarding when the prompt was provided to the first interface of the selected organization.

9. The mon-transitory computer readable medium of claim 7, wherein the prompt comprises a comparison between a plurality of the micro-journal entries and is configured to receive an input regarding which of the plurality of the micro-journal entries is more important.

10. The non-transitory computer readable medium of claim 7, wherein the second interface is configured to provide a recommendation for the organization from the plurality of organizations based on the analytics results, wherein upon selection of pushing the recommendation to the organization, configuring the first interface to provide one of a notification or a prompt according to the recommendation.

11. The non-transitory computer readable medium of claim 7, wherein the second interface is configured to display the analytics results for the selected organization.

12. The non-transitory computer readable medium of claim 7, wherein the configuring of the first interface is conducted only for the selected organization from the plurality of organizations.

13. An apparatus, comprising:
a processor, configured to:
provide a first interface directed at a plurality of organizations, the first interface configured to receive micro-journal entries;
aggregate the micro-journal entries across the plurality of organizations;
provide analytics results of the micro-journal entries across the plurality of organizations to a second interface;
receive, through the second interface, a selection of an organization from the plurality of organizations for pushing a prompt based on the analytics results; and
configure the first interface of the selected organization from the plurality of organizations to provide the prompt, the prompt configured to receive additional micro-journal entries.

14. The apparatus of claim 13, wherein the second interface is configured to initiate recording of aggregated results for the provided prompt and provide an indication regarding when the prompt was provided to the first interface of the selected organization.

15. The apparatus of claim 13, wherein the prompt comprises a comparison between a plurality of the micro-journal entries and is configured to receive an input regarding which of the plurality of the micro-journal entries is more important.

16. The apparatus of claim 13, wherein the second interface is configured to provide a recommendation for the organization from the plurality of organizations based on the analytics results, wherein upon selection of pushing the recommendation to the organization, the processor is configured to configure the first interface to provide one of a notification or a prompt according to the recommendation.

17. The apparatus of claim 13, wherein the second interface is configured to display the analytics results for the selected organization.

18. The apparatus of claim 13, wherein the processor is configured to configure the first interface only for the selected organization from the plurality of organizations.
